(19) United States
(12) Patent Application Publication
(10) Pub. No.: US 2025/0309967 A1
(43) Pub. Date: Oct. 2, 2025

(54) BEAM FAILURE RECOVERY FOR SEAMLESS MOBILITY

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US)

(21) Appl. No.: 19/080,741

(22) Filed: Mar. 14, 2025

Related U.S. Application Data
(60) Provisional application No. 63/571,307, filed on Mar. 28, 2024.

(51) Int. Cl. H04B 7/06; H04L 5/00; H04W 24/04

(52) U.S. Cl. CPC H04B 7/06964; H04L 5/0048; H04L 5/0053; H04W 24/04

(57) ABSTRACT

Methods and apparatuses for beam failure recovery for seamless mobility. A method of operating a user equipment (UE) includes receiving a list of first reference signals (RSs) for beam recovery, receiving a transmission configuration indicator (TCI) state for reception or transmission of downlink (DL) channels or uplink (UL) channels, respectively, and determining an occurrence of a beam failure. The method further includes determining a set of first RSs from the list of first RSs based on the TCI state, measuring a reference signal received power (RSRP) of RSs from the set of first RSs, identifying a first RS from the RSs based on the RSRP, and transmitting a beam failure recovery request (BFRQ) in a channel indicating an identity of the first RS.

### CROSS-REFERENCE TO RELATED AND CLAIM OF PRIORITY

The present application claims priority under 35 U.S.C. § 119 (e) to U.S. Provisional Patent Application No. 63/571,307 filed on Mar. 28, 2024, which is hereby incorporated by reference in its entirety.

### TECHNICAL FIELD

The present disclosure relates generally to wireless communication systems and, more specifically, the present disclosure relates to methods and apparatuses for beam failure recovery for seamless mobility.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam failure recovery for seamless mobility.

In one embodiment, a user equipment (UE) is provided. The UE includes a transceiver configured to receive a list of first reference signals (RSs) for beam recovery and receive a transmission configuration indicator (TCI) state for reception or transmission of downlink (DL) channels or uplink (UL) channels, respectively. The UE further includes a processor operably coupled to the transceiver. The processor is configured to determine an occurrence of a beam failure, determine a set of first RSs from the list of first RSs based on the TCI state, measure a reference signal received power (RSRP) of RSs from the set of first RSs, and identify a first RS from the RSs based on the RSRP. The transceiver is further configured to transmit a beam failure recovery request (BFRQ) in a channel indicating an identity of the first RS.

In another embodiment, a base station (BS) is provided. The BS includes a transceiver configured to transmit a list of first RSs for beam recovery and transmit a TCI state for transmission or reception of DL channels or UL channels, respectively. The BS further includes a processor operably coupled to the transceiver. The processor is configured to determine a set of first RSs from the list of first RSs based on the TCI state. The transceiver is further configured to receive a BFRQ in a channel indicating an identity of a first RS, from the first set of RSs, for beam failure recovery.

In yet another embodiment, a method of operating a UE is provided. The method includes receiving a list of first RSs for beam recovery, receiving a TCI state for reception or transmission of DL channels or UL channels, respectively, and determining an occurrence of a beam failure. The method further includes determining a set of first RSs from the list of first RSs based on the TCI state, measuring a RSRP of RSs from the set of first RSs, identifying a first RS from the RSs based on the RSRP, and transmitting a BFRQ in a channel indicating an identity of the first RS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example radio access network (RAN) protocol stack according to embodiments of the present disclosure;

FIG. 8 illustrates a diagram of example functional split points/options according to embodiments of the present disclosure;

FIG. 9 illustrates a diagram of example functional split points/options according to embodiments of the present disclosure;

FIG. 10 illustrates a diagram of an example synchronization signal/physical broadcast channel (SS/PBCH) block according to embodiments of the present disclosure;

FIG. 11A illustrates a flowchart of an example contention based random access (CBRA) procedure according to embodiments of the present disclosure;

FIG. 11B illustrates a flowchart of an example contention free random access (CFRA) procedure according to embodiments of the present disclosure;

FIG. 12A illustrates a flowchart of an example CBRA procedure according to embodiments of the present disclosure;

FIG. 12B illustrates a flowchart of an example CFRA procedure according to embodiments of the present disclosure;

FIG. 13 illustrates examples of a UE moving on a trajectory located in co-located and distributed port groups (PGs) according to embodiments of the present disclosure;

FIG. 14 illustrates an example system for UE switching/connecting to a different RU according to embodiments of the present disclosure;

FIG. 15 illustrates an example system for serving cells according to embodiments of the present disclosure;

FIGS. 16A, 16B, and 16C illustrate a diagram of example radio access network (RAN) configurations according to embodiments of the present disclosure;

FIG. 17 illustrates a diagram of an example RAN configuration according to embodiments of the present disclosure;

FIG. 18 illustrates a flowchart of an example UE procedure for determining presence of beam failure according to embodiments of the present disclosure;

FIG. 19 illustrates a flowchart of an example UE procedure for determining presence of beam failure according to embodiments of the present disclosure;

FIG. 20 illustrates a flowchart of an example UE procedure for determining presence of beam failure according to embodiments of the present disclosure;

FIG. 21 illustrates a flowchart of an example UE procedure for determining presence of beam failure according to embodiments of the present disclosure; and

FIG. 22 illustrates an example method performed by a UE in a wireless communication system according to embodiments of the present disclosure.

### DETAILED DESCRIPTION

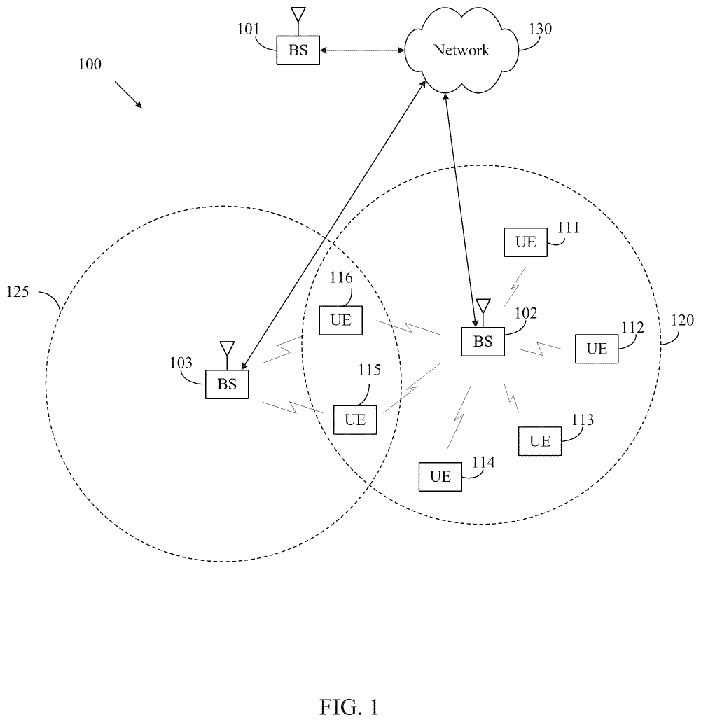

FIGS. 1-22, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0, “NR; Physical channels and modulation;” [REF 2] 3GPP TS 38.212 v18.1.0, “NR; Multiplexing and Channel coding;” [REF 3] 3GPP TS 38.213 v18.1.0, “NR; Physical Layer Procedures for Control;” [REF 4] 3GPP TS 38.214 v18.1.0, “NR; Physical Layer Procedures for Data;” [REF 5] 3GPP TS 38.321 v18.0.0, “NR; Medium Access Control (MAC) protocol specification;” and [REF 6] 3GPP TS 38.331 v18.0.0, “NR; Radio Resource Control (RRC) Protocol Specification”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam failure recovery for seamless mobility. In certain embodiments, one or more of the gNBs 101-103 include circuitry, programing, or a combination thereof to support beam failure recovery for seamless mobility.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

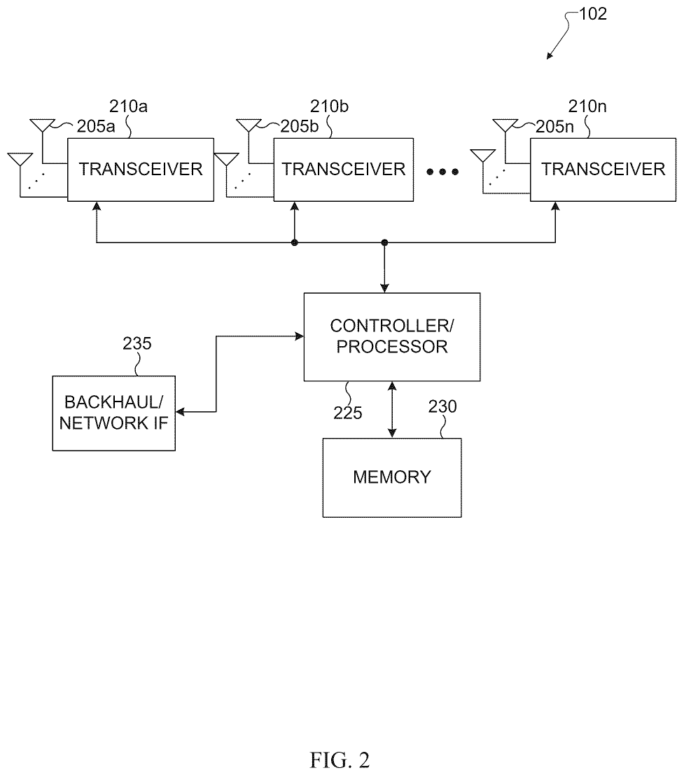

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting beam failure recovery for seamless mobility. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

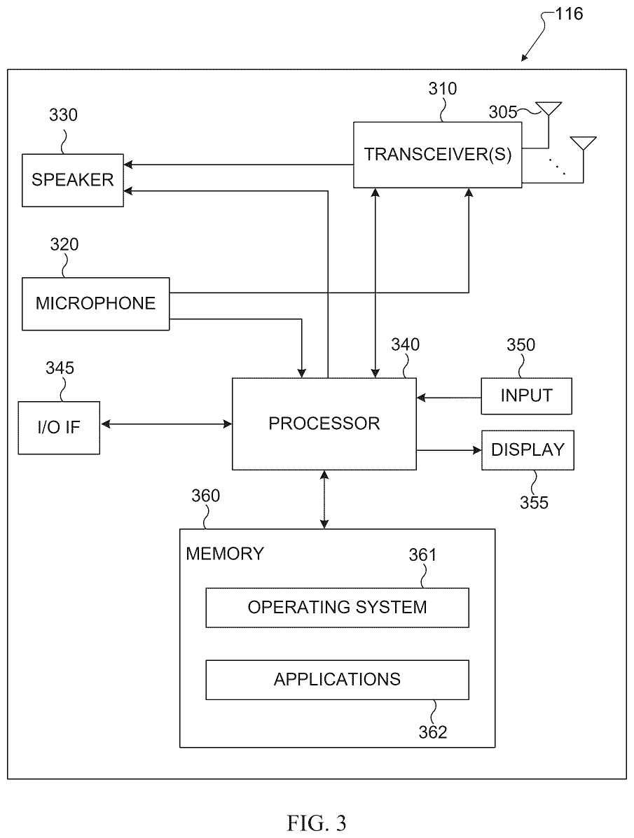

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform beam failure recovery for seamless mobility, as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

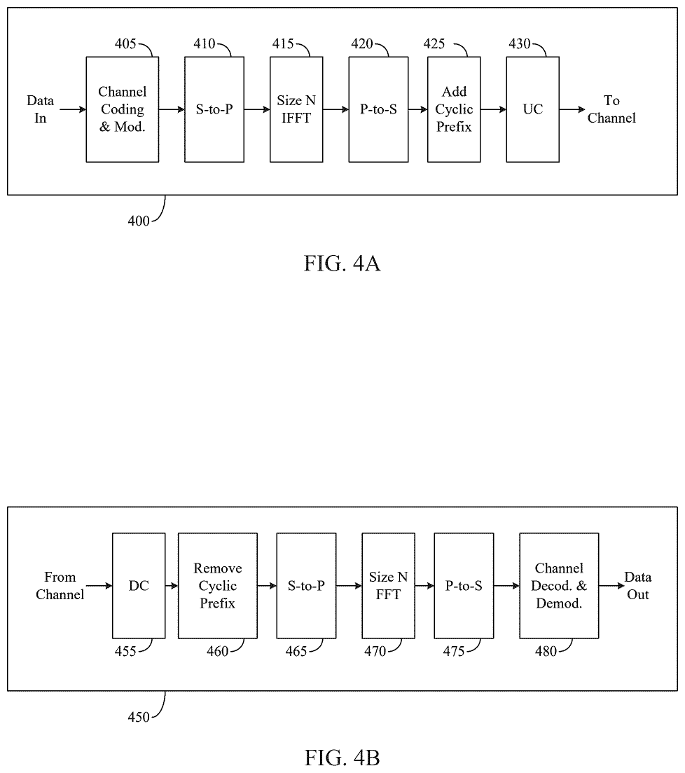

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 supports beam failure recovery for seamless mobility as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

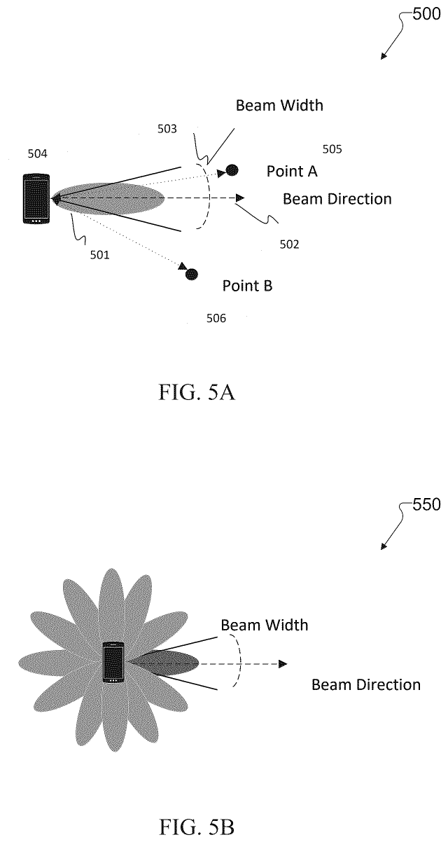

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

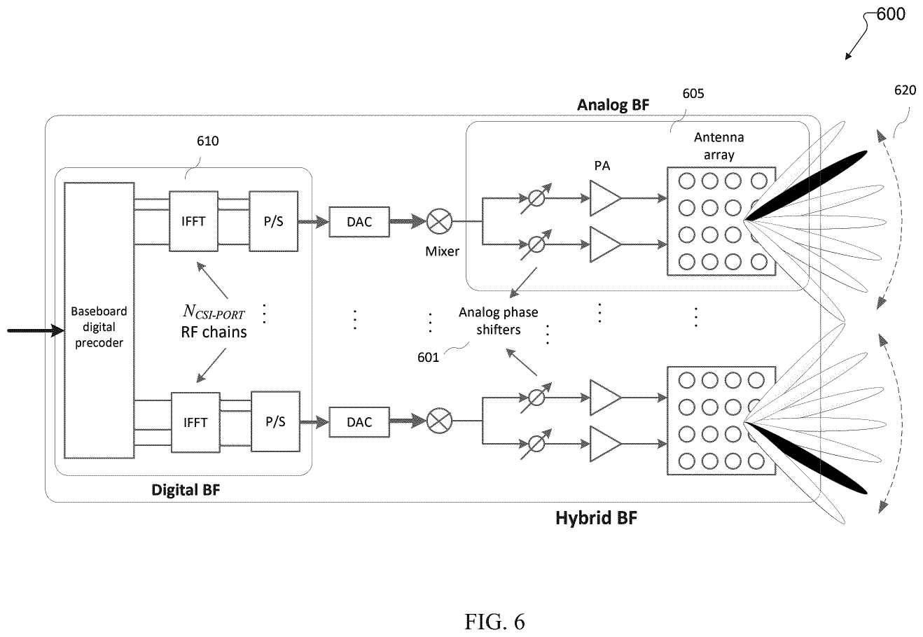

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

In this disclosure, [DEF1] a beam can be determined by any of:
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or TCI state or spatial relation or the one (or two) port(s) identifies the beam.

According to [DEF1], the TCI state and/or the spatial relation reference RS can determine a spatial Rx filter or quasi-co-location information for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter or quasi-co-location information for reception of uplink channels at the gNB.

Likewise, for [DEF2], the port with dynamic virtualization and/or the PG with dynamic indication of one (or two) ports can determine a spatial Rx filter or quasi-co-location information or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or quasi-co-location information or a port or a PG for reception of uplink channels at the gNB (e.g., the BS 102).

Rel-17 introduced the unified TCI framework, where a unified or main or indicated TCI state is signaled to the UE. The unified or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [[REF 4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE (e.g., the UE 116) is indicated a TCI state by MAC CE when the MAC CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose-designed channel or DCI Format for TCI state indication is applied after a beam application time from the corresponding HARQ-ACK feedback.

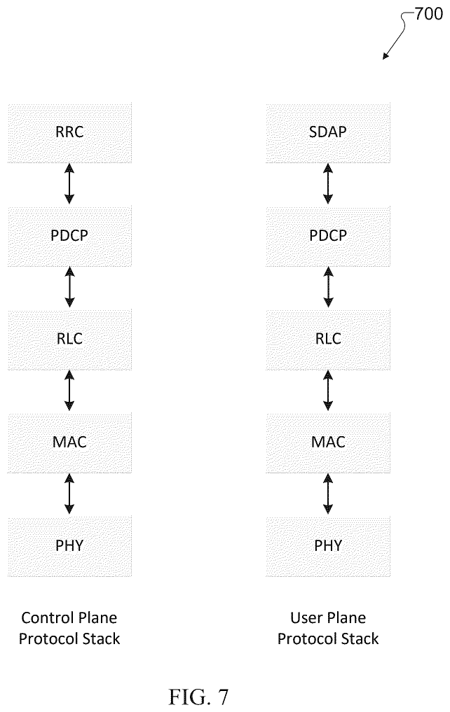

FIG. 7 illustrates a diagram of an example RAN protocol stack 700 according to embodiments of the present disclosure. For example, protocol stack 700 can be implemented by the BS 102 and the UE 116 of FIG. 1. This example is for illustration only and other embodiments can be used without departing from the scope of the present disclosure.

With reference to FIG. 7, an example of the protocol stack of NR networks is shown including physical (PHY) layer, medium access control (MAC) layer, radio link control (RLC) layer, packet data convergence protocol (PDCD) layer, for control plane there is radio resource control (RRC) layer, and for user plane there is service data adaptation protocol (SDAP) layer.

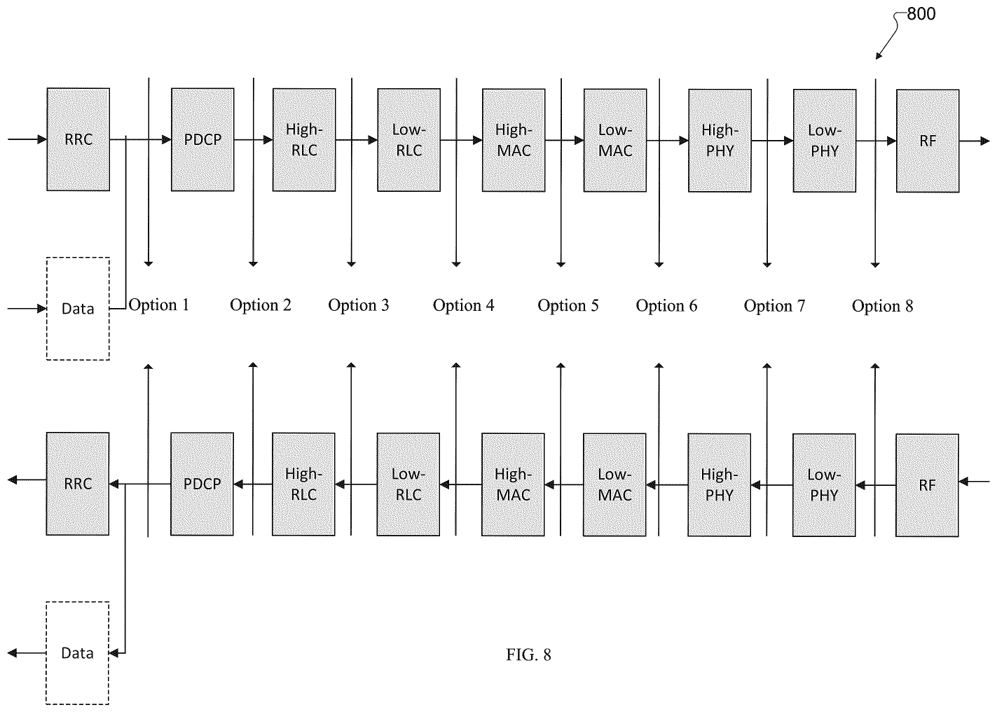

FIG. 8 illustrates a diagram of example functional split points/options 800 according to embodiments of the present disclosure. For example, functional split points/options 800 may be implemented by the BS 102 of FIG. 2. This example is for illustration only and other embodiments can be used without departing from the scope of the present disclosure.

FIG. 9 illustrates a diagram of example functional split points/options 900 according to embodiments of the present disclosure. For example, functional split points/options 900 may be implemented by the BS 103 of FIG. 1. This example is for illustration only and other embodiments can be used without departing from the scope of the present disclosure.

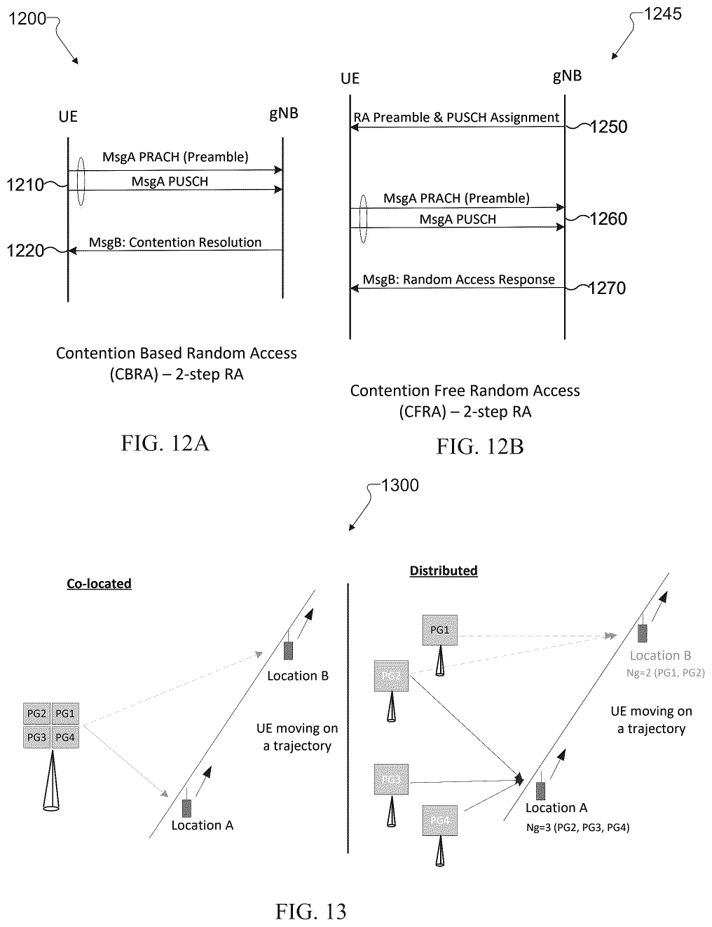

There can be different mappings of the layers of the protocol stack to actual devices implementing these functionalities. In one example, layers of the protocol stack can be mapped to a single device. In another example, the layers of the protocol stack can be split across multiple devices. 3GPP [TR 38.801] evaluated different functional split points between a central unit (CU) containing the higher layers of the protocol stack and a distributed unit (DU) containing the lower layers of the protocol stack. The functional split options evaluated by 3GPP are illustrated in FIG. 8 (TR 38.801-FIG. 12.1.1-1). For example, with functional split option 2, a CU contains the RRC and packet data convergence protocol (PDCP) layers, while a DU contains the RLC, MAC and PHY layers.

Multiple split options are also feasible, for example, in additional to the higher layer split between the CU and DU (e.g., functional split option 2), there can be a split within the DU. For example, the DU can be split into DU and remote unit (RU). The O-RAN alliance has been evaluating a lower layer functional split, where the lower PHY and the RF reside in a remote unit (RU), while the higher PHY and layers herein reside in the DU or CU. The lower level split being evaluated by the O-RAN alliance is similar to functional split option 7 of FIG. 8. There are various sub-options being evaluated for option 7 to define where the split occurs within the physical layer occurs. FIG. 9 illustrates an example protocol stack with two functional split points, the first between the CU and the DU and the second between the DU and the RU.

In NR/5G, a geographical area served by the network (e.g., the network 130) can be partitioned into cells as mentioned herein. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

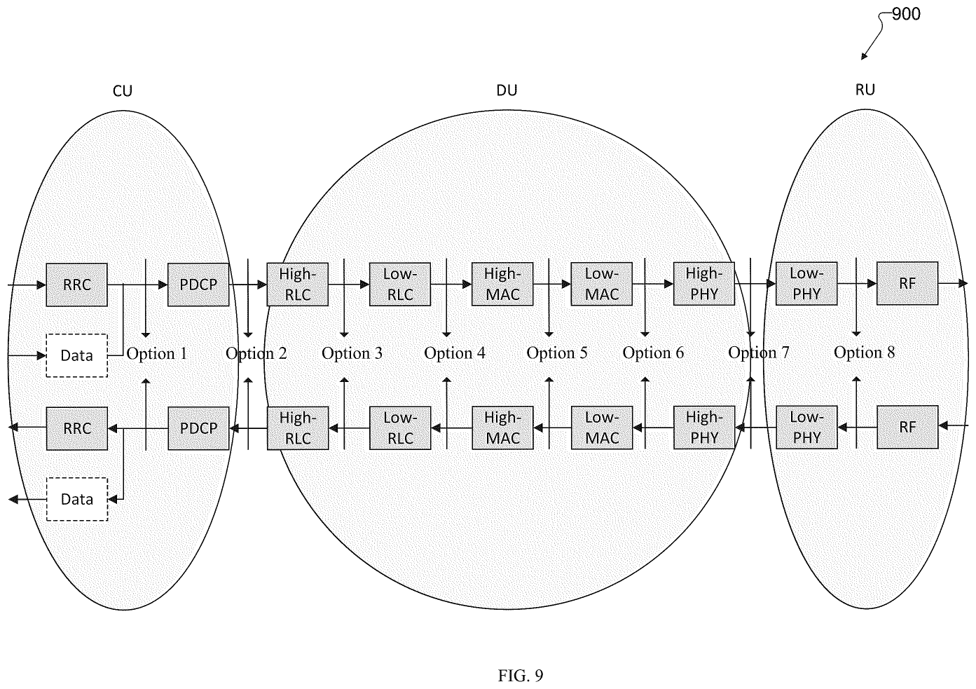

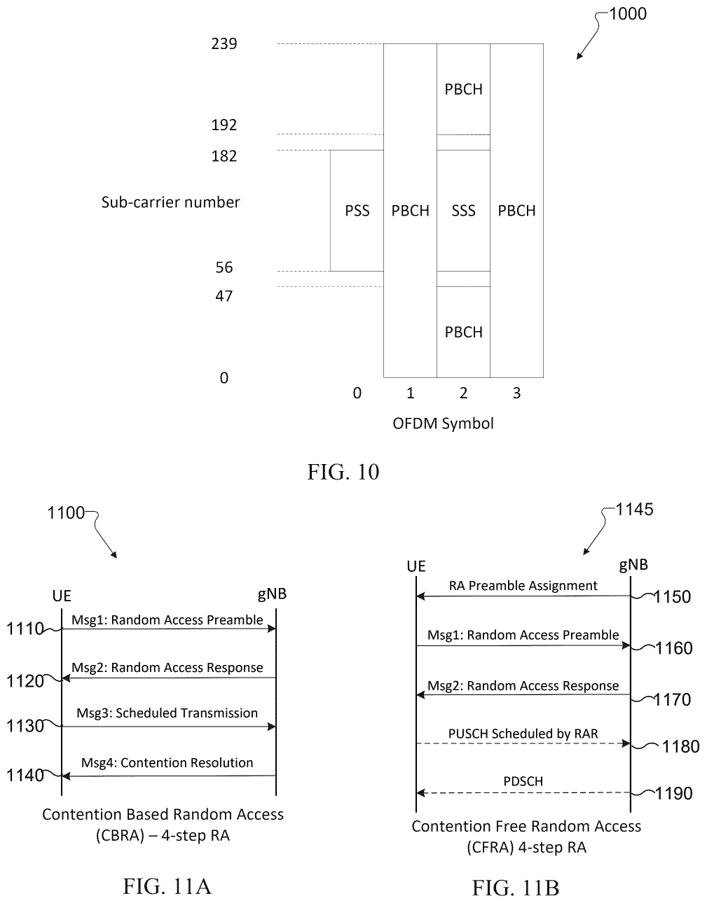

FIG. 10 illustrates a diagram of an example SS/PBCH block 1000 according to embodiments of the present disclosure. For example, SS/PBCH block 1000 can be utilized by any of the UEs 111-116 of FIG. 1. This example is for illustration only and other embodiments can be used without departing from the scope of the present disclosure.

In NR/5G, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (240 subcarriers), as illustrated in FIG. 10.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of resource blocks (RBs)) and the resource allocated to an RO in the time domain (e.g., number of OFDMA symbols or number of slots), depend or the preamble sequence length, sub-carrier spacing of the preamble, sub-carrier spacing of the PUSCH in the UL bandwidth part (BWP), and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1].

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [REF 3]:
First, in increasing order of preamble indexes within a single PRACH occasion.
1 Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH occasions.

FIG. 11A illustrates a flowchart of an example CBRA procedure 1100 according to embodiments of the present disclosure. For example, CBRA procedure 1100 can be performed by the UE 116 and the gNB 102 and/or network 130 in the wireless network 100 of FIG. 1. This example is for illustration only and other embodiments can be used without departing from the scope of the present disclosure.

The procedure begins in 1110, a UE transmits a Msg1: random access preamble to a gNB. In 1120, the gNB transmits a Msg2: random access response to the UE. In 1130, the UE transmits a Msg3: scheduled transmission to the gNB. In 1140, the gNB transmits Msg4: contention resolution to the UE.

FIG. 11B illustrates a flowchart of an example CFRA procedure 1145 according to embodiments of the present disclosure. For example, CFRA procedure 1145 can be performed by the UE 116 and the gNB 103 and/or network 130 in the wireless network 100 of FIG. 1. This example is for illustration only and other embodiments can be used without departing from the scope of the present disclosure.

The procedure begins in 1150, a gNB transmits a RA preamble assignment to a UE. In 1160, the UE transmits a Msg1: random access preamble to the gNB. In 1170, the gNB transmits a Msg2: random access response to the UE. In 1180, the gNB transmits Msg4: content resolution to the UE. Then the UE may transmit PUSCH scheduled by RAR, to the gNB (1180) and the gNB may transmit PDSCH to the UE (1190).

FIG. 12A illustrates a flowchart of an example CBRA procedure 1200 according to embodiments of the present disclosure. For example, CBRA procedure 1200 can be performed by the UE 115 and the gNB 102 and/or network 130 in the wireless network 100 of FIG. 1. This example is for illustration only and other embodiments can be used without departing from the scope of the present disclosure.

The procedure begins in 1210, a UE transmits MsgA PRACH (preamble) and MsgA PUSCH to a gNB. In 1220, the gNB transmits MsgB: contention resolution to the UE.

FIG. 12B illustrates a flowchart of an example CFRA procedure 1245 according to embodiments of the present disclosure. For example, CFRA procedure 1245 can be performed by the UE 115 and the gNB 103 and/or network 130 in the wireless network 100 of FIG. 1. This example is for illustration only and other embodiments can be used without departing from the scope of the present disclosure.

The procedure begins in 1250, a gNB transmits a RA preamble and PUSCH assignment to a UE. In 1260, the UE transmits MsgA PRACH (preamble) and MsgA PUSCH to the gNB. In 1270, the gNB transmits MsgB: random access response to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIGS. 11A and 11B;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE (RRC setup).

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

Rel-16, introduced a new random access procedure; Type-2 random access procedure, also known as 2-step random access procedure (2-step RACH), is as illustrated in FIGS. 12A and 12B, that combines the preamble and PUSCH transmission into a single transmission from the UE (e.g., the UE 116) to the gNB, which is known as MsgA. Similarly, the RAR and the PDSCH transmission (e.g. Msg4) are combined into a single downlink transmission from the gNB to the UE, which is known as MsgB.

FIG. 13 illustrates examples of a UE moving on a trajectory 1300 located in co-located and distributed PGs according to embodiments of the present disclosure. For example, UE moving on a trajectory 1300. For example, UE moving on a trajectory 1300 can be implemented by any of the UEs 111-116 of FIG. 1. This example is for illustration only and can be used without departing from the scope of the present disclosure.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. Alternatively, (2) can be PG-based mobility, as illustrated in FIG. 13. While the user moves from a location A to another location B, the set of PGs is updated from {PG2, PG3, PG4} to {PG1, PG2}. Consequently, a seamless beam-based (as opposed to cell-based) mobility is feasible especially for RRC-connected UEs.

To improve handover procedures, 3GPP introduced several handover enhancements which include:
Dual Active Protocol Stack (DAPS): The source gNB connection is maintained, i.e., a UE continues DL data reception from the source gNB and UL data transmission to the source gNB, after reception of the RRC message for handover, and until the source gNB is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE switches to the target cell following the cell switch command. The benefit of cell switch command is to reduce handover latency.

However, the methods mentioned herein involve higher layer reconfiguration as part of the handover procedure. Embodiments of the present disclosure recognizes that this increases latency, interruption, and overhead. Alternatively, as described in U.S. patent application Ser. No. 19/044,590, filed on Feb. 3, 2025 (the '590 application), which is incorporated by reference in its entirety, for connected mode UEs, beam-based indication can be used for mobility, where, a beam indication (e.g., TCI state) for that includes or is associated with reference signal associated with (e.g., transmitted from) from a TRP or RU associated with a cell other than the serving cell is indicated to the UE. The UE accordingly can receive/transmit from/to the TRP or RU associated with the cell other than the serving cell. In one example, the UE can maintain the serving cell identified at the time of link establishment, and as the UE traverses the network, beam indication is used to change the TRP or RU through which a UE communicates. In one example, a first cell is a serving of the UE, and a second cell is a cell associated with a TRP or a RU through which the UE communicates.

When the UE is communicating through a TRP or RU associated with a second cell other than that of the serving cell (i.e., the first cell, e.g., cell at link establishment), and if a beam failure, were to occur, a beam failure recovery procedure is triggered, as the UE has been communicating through the TRP or RU associated with the second cell prior to beam failure, it is reasonable to take into account that a newly identified beam after beam failure recovery can be associated with a TRP or a RU of the second cell or a geographically close TRP or RU.

In this disclosure the configuration of beam failure recovery reference signals and associated resources is provided for indication of the beam failure recovery reference signals during the beam recovery procedure, when beam failure occurs while the UE is communicating with a TRP or RU associated with a cell other than the serving cell.

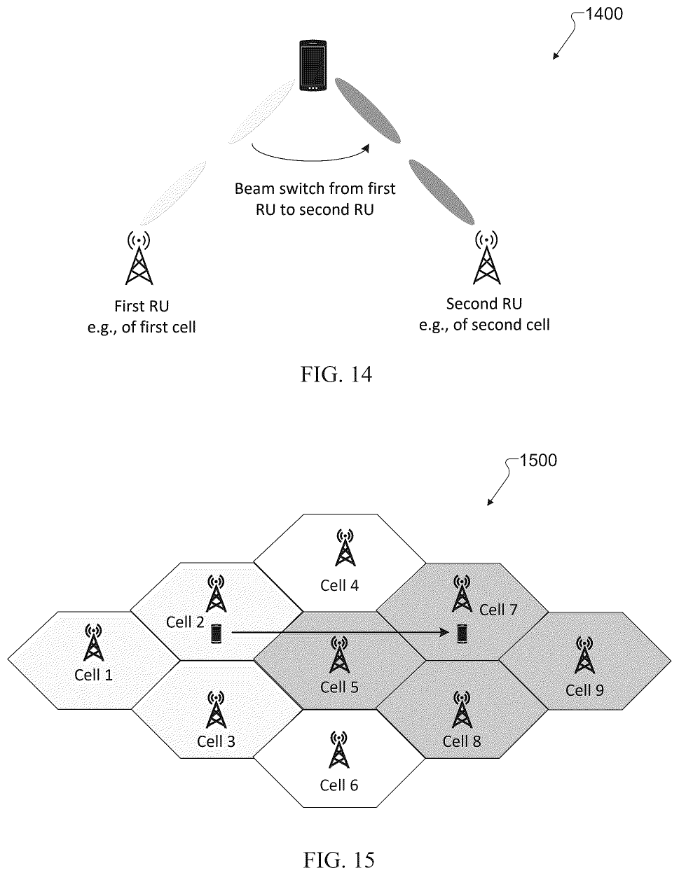

FIG. 14 illustrates an example system 1400 for UE switching/connecting to a different RU or cell according to embodiments of the present disclosure. For example, system 1400 can be implemented in the wireless network 100 of FIG. 1. This example is for illustration only and other embodiments can be used without departing from the scope of the present disclosure.

As mentioned herein, a geographical area served by a network is partitioned into cells. Cells can be mapped to or associated with RUs, DUs or CUs. A UE can connect to the network through one or more RUs associated with a serving cell. Or depending on propagation channel conditions, a UE can connect through RUs not associated with the serving cell. As a UE moves within the geographical area covered by the network, the cell through which the UE connects to the network changes, and hence the RU(s) through which the UE connects to the network change. For example, for dedicated channels or signals, a change in RU can be signaled to the UE as a change in a spatial domain filter (beam or port/PG), the UE communicates to the network through a first RU using a first spatial domain filter (beam or port/PG) as illustrated in FIG. 14, the UE is then signaled a second spatial domain transmission filter (beam or port/PG) associated with a second RU to communicate to the network through the second RU.

FIG. 15 illustrates an example system 1500 for serving cells according to embodiments of the present disclosure. For example, system 1500 can be implemented in the wireless network 100 of FIG. 1. This example is for illustration only and other embodiments can be used without departing from the scope of the present disclosure.

As the UE moves throughout the geographical area served by the network, the TRP or RU or cell through which the UE communicates changes, based on the UE's location within the geographical area as illustrated in FIG. 15. In FIG. 15, as an example, a UE moves from cell 2, where the UE communicates through the TRP or RU of cell 2, to cell 5 where the UE communicates through the TRP or RU of cell 5. In one example, there is no cell change or switch when the UE communicates through the TRP or RU of cell 5, a beam indication to the UE is used to indicate a beam associated with the TRP or RU of cell 5 through which the UE communicates. The UE continues to move to cell 7, where the UE communicates through the TRP or RU of cell 7. In one example, there is no cell change or switch when the UE communicates through the TRP or RU of cell 7, a beam indication to the UE is used to indicate a beam associated with the TRP or RU of cell 7 through which the UE communicates.

If a beam failure where to occur when the UE is in cell 7, it is reasonable to take into account that beam failure detection and beam failure recovery signaling is transmitted or received through a TRP or RU associated with cell 7 or a neighboring TRP or RU.

In NR, beam failure detection and recovery involves the following steps:
Beam failure detection wherein a UE is configured with a set of resources q₀ (or q_{0,0} and q_{0,1}) of periodic CSI-RS resource indexes for link failure detection, the UE assess the radio link quality (e.g., L1-RSRP) and if the radio link quality is worse than a threshold, the physical layer informs the higher layers. The MAC layer counts the number of beam failure instance indications from the physical layer, and triggers beam failure recovery procedure when the number of beam failure instances exceeds a threshold within a window.
New beam identification, wherein a UE is configured with a set of resources q₁ (or q₁,0 and q_{1,1}) of periodic CSI-RS resource indexes or SS/PBCH block indexes for new beam identification. Wherein, the physical layer provides to higher layers the periodic CSI-RS indexes and/or SS/PBCH block indexes from the set q₁ (or q₁,0 and q_{1,1}) with corresponding L1-RSRP measurement larger than or equal to a threshold.
When beam failure is detected for the primary cell (PCell) or primary secondary cell (PSCell) a random access procedure can be triggered (beam failure recovery request (BFRQ)) using a dedicated PRACH configuration associated with the new beam identified. When the beam failure is detected for SCell, a scheduling request (e.g., link recovery request (LLR)) is sent to the network on the PCell or PSCell, and the UE provides an indication of the newly identified beam.
The UE monitors PDCCH in a search space set provided by recoverySearchSpaceId for detection of a DCI format with cyclic redundancy check (CRC) scrambled by cell-radio network temporary identifier (C-RNTI) or modulation and coding scheme (MCS)-C-RNTI (beam failure recovery response). After the UE detects a DCI format with CRC scrambled by C-RNTI or MCS-C-RNTI in the search space set provided by recovery SearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

A PRACH configuration includes the following information: (1) Information related to the preamble format and the preamble sequence such as: PRACH preamble format, zero correlation zone config (to determine the Ncs), root sequence index, and restricted set configuration (for long preamble formats, e.g., with sequence length 839). (2) time domain information of the PRACH occasion, such as radio frame, sub-frame within radio frame, PRACH slot within subframe, and starting symbol with PRACH slot, PRACH duration in symbols. (3) frequency domain information of the PRACH occasion such as starting PRB, and number of FDMed frequency occasions. (4) Number of SSBs mapped to a PRACH occasion.

In one example, a PRACH configuration is provided, that determines the available PRACH occasions. The PRACH occasions are indexed first in increasing order of frequency resource indexes for frequency multiplexed PRACH occasions; second in increasing order of time resource indexes for time multiplexed PRACH occasions within a PRACH slot; and third in increasing order of indexes for PRACH slots. Each PRACH occasion can include N preamble indices, e.g., 0, 1, . . . , N−1. In one example N=64.

Reference signals for new beam identification (e.g., q₁ (or q_{1,0} and q_{1,1})) are associated by configuration with one or more PRACH occasions and with a preamble index. When beam failure is detected, a new beam is identified, and a corresponding PRACH occasion and preamble index is determined based on the association mentioned herein. A PRACH is transmitted in the corresponding PRACH occasion and using the preamble index.

To minimize interference between different TRPs or RUs or cells, different PRACH configurations can be used across the different TRPs or RUs or cells, and hence as the UE (e.g., the UE 116) traverses the geographical area covered the network, the PRACH resources to use (e.g., as part of a beam failure recovery procedure), depend on the location of the UE within the network, e.g., based on the TRP or RU the UE used at the time of beam failure. In this disclosure, configuration, indication, and association of signals and channels used for beam failure recovery with seamless mobility (e.g., beam based mobility) is provided as the UE traverses the TRPs or RUs of the network.

The present disclosure relates to a NR/5G and/or 6G communication system.

This disclosure provides aspects related to mobility in a network for user in connected mode. The beam failure recovery procedure is provided. Specifically, the following aspects are provided:
Beam indication is used to update the user's connectivity to network.
Updating of resources for beam failure detection reference signal (BFD-RS), new beam identification reference signal (NBI-RS), BFRQ and beam failure recovery response (BFRR) based on UE's location within the network (e.g., based on TCI state of UE or based on RU or TRP or cell through which the UE communicates with the network).
Updating reference signals used for beam failure recovery and beam failure recovery based on the UE's location in the network, e.g., based on the TRP(s) or RU(s) or cell(s) through which the UE communicates with the network.
Multiple PRACH configurations for beam failure recovery request, e.g., to accommodate a large number of TRPs or RUs or cells in the network.
Linkage of a beam failure recovery signal to a PRACH configuration.
Multiple recovery search space configurations, e.g., to accommodate a large number of TRPs or RUs or cells in the network.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs of a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE or can be UE common (e.g., to a group of UEs or to all UEs of a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L (i), where i can take N values, and L (i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as non zero power (NZP) CSI-RS and/or SSB) with the result of the measurement used for calculating a beam report (e.g., including at least one L1-RSRP/L1-signal-to-interference-plus-noise ratio (SINR) accompanied by at least one channel quality indicator report interval (CRI) or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, a beam or PG management reference signal refers to a reference signal, a UE can use for beam or PG management procedure. A beam or PG management procedure can include:
Initial beam or PG acquisition for identifying a beam or a beam pair (or port/PG pair) between two devices (e.g., UE and gNB/TRP or between two UEs) during channel setup or link establishment. This includes initial beam (port) sweeping (within a PG) to identify a beam (or port) pair between the two devices. This can also include identifying a beam or a beam pair (or port/PG pair) between a UE and new gNB/TRP in case of handover.
Beam or PG maintenance for refining and tracking the beam or PG as the UE moves around or the channel conditions change. This includes beam or PG measurement and reporting, and beam or port/PG indication signaling.
Beam or PG failure detection and recovery, an emergency-only procedure for determining when a beam has failed, and identifying a new beam to use instead. Beam failure events are typically rare and, in the unlikely event that a beam fails, beam recovery should be fast and before the link fails.

In one example, beam or PG management reference signals, also referred to as reference signals in this document can include:

1 A SS/PBCH block, which includes one or more synchronization signals carrying a cell ID (or a gNB/TRP ID or a RU ID), and a channel carrying minimum system information or part of the minimum system information, wherein the minimum system information is the information required by the UE to access the network (e.g., the network 130). In one example, the SS/PBCH block is not associated with PCI. In one example, the SS/PBCH is associated with PCI. In one example, the SS/PBCH block is a non-cell defining (NCD) SS/PBCH block. In one example, the SS/PBCH block is a cell defining (CD) SS/PBCH block.

1 low power synchronization signal (LP-SS). In one example, LP-SS includes one or more synchronization signals carrying a cell ID (or a gNB/TRP ID or a RU ID). In one example, LP-SS is based on on-off keying modulation. In one example, LP-SS is received or transmitted on a low power radio separate from the main radio. In one example, the LP-SS is not associated with PCI. In one example, the LP-SS is associated with PCI.
Channel state information reference signal (CSI-RS). In one example, the CSI-RS is not associated with a PCI. In one example, the CSI-RS has no source RS, e.g., the CSI-RS is the root of the QCL relation. In one example, the CSI-RS is QCLed to another CSI-RS. In one example, the CSI-RS is QCLed to a SS/PBCH block. In one example, the CSI-RS is QCLed with LP-SS. In one example, the CSI-RS is associated with a PCI. In one example, the CSI-RS has one antenna port. In one example, the CSI-RS has more than one antenna port.
1 antenna port of a CSI-RS.
Sounding reference signal (SRS).

In one example, the CSI-RS and/or LP-SS and/or SS/PBCH block (e.g., non-cell defining synchronization signal (NCD-SS)/PBCH block) is transmitted from multiple RUs or multiple TRPs with single frequency network (SFN) properties. In one example, the same time and frequency resources and a same sequence is used to transmit CSI-RS and/or LP-SS and/or SS/PBCH block from multiple RUs or from multiple TRPs.

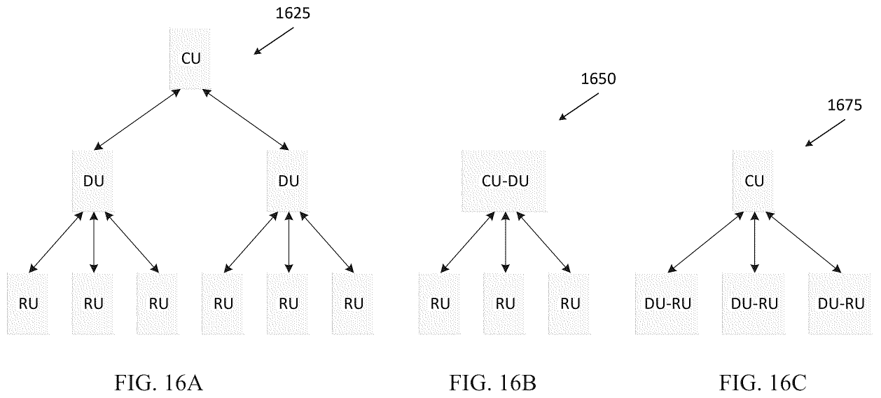

FIGS. 16A, 16B, and 16C illustrate a diagram of example RAN configurations 1625, 1650, and 1675, respectively, according to embodiments of the present disclosure. For example, RAN configurations 1625, 1650, and 1675, respectively, can be implemented by gNB 102 and/or network 130 in the wireless network 100 of FIG. 1. This example is for illustration only and other embodiments can be used without departing from the scope of the present disclosure.

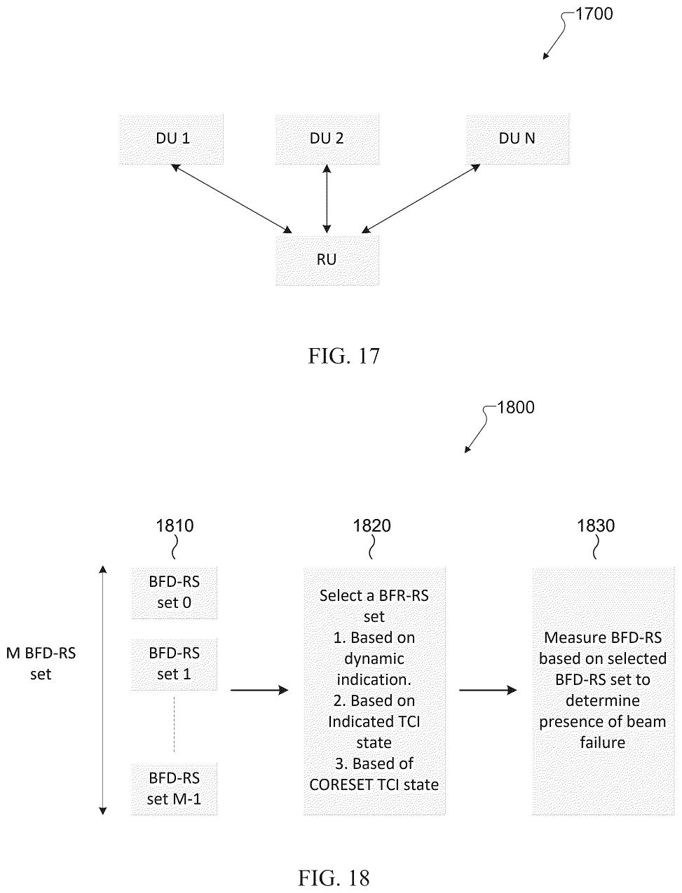

FIG. 17 illustrates a diagram of an example RAN configuration 1700 according to embodiments of the present disclosure. For example, RAN configuration 1700 can be implemented by gNB 103 and/or network 130 in the wireless network 100 of FIG. 1. This example is for illustration only and other embodiments can be used without departing from the scope of the present disclosure.

In one example, a network can be deployed, wherein the network includes CUs, DUs and RUs. In one example, one CU can serve one or multiple DUs and one DU can serve one or multiple RUs as illustrated in FIG. 16. In FIG. 16A, the CU, DU and RU can be separate entities. In FIG. 16B, the CU and DU are included in a same entity that is separate from the RU. In FIG. 16C, the DU and RU are included in a same entity that is separate from the CU. In one example, the CU, DU and RU are included in the same entity.

In one example, an RU (or O-RU) is functionally equivalent to a port or a PG (with QCL properties as described herein), and hence can be replaced with the term, “port or PG”. In the rest of the disclosure, the term RU is used for illustration purpose only, hence can be replaced with any functionally equivalent term such as a port or PG.

Likewise, the term beam can functionally equivalent to a port or a PG (with QCL TypeD or spatial filter as described herein) or TCI state, and hence can be replaced with the term, “port or PG” or TCI state. In the rest of the disclosure, the term beam is used for illustration purpose only, hence can be replaced with any functionally equivalent term such as a port or PG or TCI state.

In one example, an RU can be connected to N DUs, as illustrated in FIG. 17. In one example, N=1. In one example, N=2. In one example, an RU can send or receive information from one DU at a time (e.g., in one slot or in one symbol or in one time-unit). In one example, an RU can send or receive information simultaneously from multiple DUs. In one example of FIG. 17, an RU is equipped with multiple panels (e.g., M panels) and each panel can serve a different cell or sector, and the UE sends and receives information associated with each panel from a corresponding DU associated with a corresponding cell or sector. In one example of FIG. 17, an RU can be associated with cell A, the RU can send or received data to or from multiple DUs associated with different cells. For example, a first DU is associated with cell A, a second DU is associated with cell B, etc.

In the examples of this disclosure a TCI state can be one of: (1) A DL TCI state for reception of DL channels and/or signals at the UE and for transmission of DL channels and/or signals at the gNB (e.g., the BS 102). (2) An UL TCI state for transmission of UL channels and/or signals at the UE and for reception of UL channels and/or signals at the gNB. (3) A joint TCI state for reception/transmission of DL/UL channels and/or signals at the UE and for transmission/reception of DL/UL channels and/or signals at the gNB.

In the examples of this disclosure a TCI state code point can include one or more of (1) DL TCI state, (2) an UL TCI state, (3) a joint TCI state and (4) a pair of DL TCI state and UL TCI state. A TCI state codepoint can be for one or more TRPs.

In the examples of this disclosure, a TCI state or TCI state code point is used as an object for beam indication or spatial domain filter indication, other objects for beam indication can be used (e.g., reference signal index, spatial relation information, etc.).

In a variant of the examples of this disclosure, when a UE measures a signal quality, SINR can be used in place of reference signal received power (RSRP). RSRP is used for conciseness, but it is understood that this can be replaced by SINR or other signal quality metric.

FIG. 18 illustrates a flowchart of an example UE procedure 1800 for determining presence of beam failure according to embodiments of the present disclosure. For example, procedure 1800 can be performed by any of the UEs 111-116 of FIG. 1, such as the UE 111. This example is for illustration only and other embodiments can be used without departing from the scope of the present disclosure.

The procedure begins in 1810, a UE is configured with multiple sets of BFD-RSs. In 1820, the UE selects a BFR-RS set based on dynamic indication, an indicated TCI state, and/or a TCI state of a CORESET. In 1830, the UE measures BFD-RS based on the selected BFD-RS set to determine the presence of a beam failure.

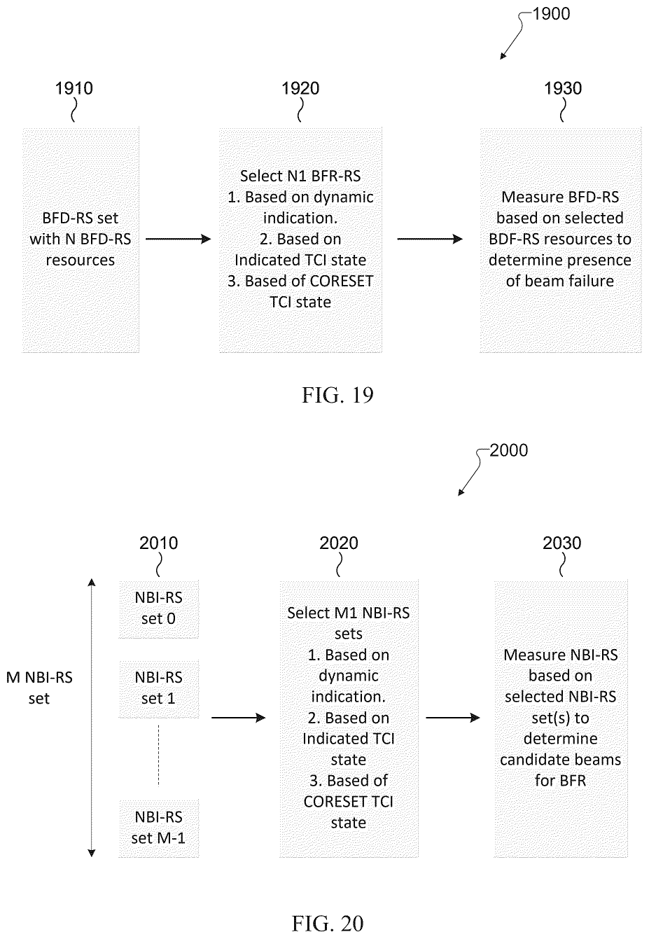

FIG. 19 illustrates a flowchart of an example UE procedure 1900 for determining presence of beam failure according to embodiments of the present disclosure. For example, procedure 1900 can be performed by any of the UEs 111-116 of FIG. 1, such as the UE 112. This example is for illustration only and other embodiments can be used without departing from the scope of the present disclosure.

The procedure begins in 1910, a UE is configured with a BFD-RS set with N BFD-RS resources. In 1920, the UE selects N1 BFR-RS based on dynamic indication, an indicated TCI state, and/or a TCI state of a CORESET. In 1930, the UE measures BFD-RS based on selected BFD-RS resources to determine presence of beam failure.

In one example, the TCI state or TCI state code point is a unified, or indicated or main TCI state used to receive DL channels and/or signals (e.g., PDCCH, PDSCH and CSI-RS following the unified or indicated or main TCI state), and/or transmit UL channels and/or signals (e.g., PUCCH, PUSCH and SRS following the unified or indicated or main TCI state). The TCI state can include a reference signal index. The reference signal (e.g., RS1) associated with the reference signal index is used for beam failure detection.

In one example, the TCI state or TCI state codepoint is associated with (1) a PDCCH channel or (2) a CORESET associated with the PDCCH channel. The TCI state can include a reference signal index. The reference signal (e.g., RS2) associated with the reference signal index is used for beam failure detection.

In one example, the reference signal (e.g., RS1 or RS2) is a channel state information reference signal (CSI-RS). In one example, the reference signal (e.g., RS1 or RS2) is a CSI-RS with one antenna port. In one example, the reference signal (e.g., RS1 or RS2) is an antenna port of a CSI-RS. In one example, the reference signal (e.g., RS1 or RS2) is SS/PBCH block. In one example, the reference signal (e.g., RS1 or RS2) is a LP-SS. In one example, the reference signal (e.g., RS1 or RS2) is a DMRS or DMRS antenna port of PDCCH or PDSCH transmission received by the UE. A UE can measure or assess the signal quality, e.g., the reference signal received power (RSRP) of the reference signal and if the RSRP falls below a threshold, a beam failure instance is declared (e.g., a beam failure instance indication is provided from the physical layer to the higher layers (e.g., MAC layer)). In one example, the UE measures a single instance of the reference signal to determine the RSRP. In one example, the RSRP is an exponential average e.g., if RSRP (n) is the RSRP at instance n and RSRP (n−1) is the RSRP at instance n−1and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal.

In one example, the UE is configured a set of reference signals (or reference signal indices) for beam failure detection. In one example, the set includes K reference signals. In one example, K=1. In one example, K=2. In one example, the reference signals are channel state information reference signal (CSI-RS). In one example, the reference signals are CSI-RS with one antenna port. In one example, the reference signals are an antenna port of a (CSI-RS). In one example, the reference signals are SS/PBCH blocks. In one example, the reference signals are combination of CSI-RS (or one antenna port CSI-RS) and SS/PBCH blocks. In one example, the reference signals are LP-SS. A UE can measure or assess the signal quality, e.g., the reference signal received power (RSRP) of the reference signals and if the RSRP falls below a threshold (in one example, for one RS in the set, in another example for each RS in the set), a beam failure instance is declared (e.g., a beam failure instance indication is provided from the physical layer to the higher layers (e.g., MAC layer)). In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal.

In one example, the UE is configured with multiple (e.g., M) sets of reference signals (or reference signal indices) for beam failure detection (e.g., BFD-RS). In one example, each set can include up to K reference signals. In one example, K=1. In one example, K=2. In one example, the reference signals are channel state information reference signal (CSI-RS). In one example, the reference signals are CSI-RS with one antenna port. In one example, the reference signals are an antenna port of a CSI-RS. In one example, the reference signals are SS/PBCH blocks. In one example, the reference signals are combination of CSI-RS (or one antenna port CSI-RS) and SS/PBCH blocks. In one example, the reference signals are LP-SS. In one example, the reference signals are a combination of CSI-RS (or one antenna port CSI-RS) and/or SS/PBCH blocks and/or LP-SS.

In one example, a UE is activated or indicated by dynamic signaling, e.g., MAC CE or L1 control information (e.g., DCI Format) a set of the M sets.

In another example, a UE is configured an association between TCI states or TCI state codepoints and the M BFD-RS sets, wherein the UE is configured with M BFD-RS sets. For example, each TCI state i is associated with BFD-RS set j. In one example, the association can be by including and a BFD-RS set index in a TCI state. In one example, the association can be by including a BFD-RS set index in dynamic signaling, e.g., MAC CE or L1 control information (e.g., DCI Format) activating TCI states. In one example, the association can be by including a BFD-RS set index in dynamic signaling, e.g., MAC CE or L1 control information (e.g., DCI Format) indicating a TCI state(s) or TCI state codepoint(s). In one example, a UE determines a set of the M sets based on an association configured/activated/indicated between a unified or indicated or main TCI state and one of the M sets. In another example, a UE determines a set of the M sets based on an association configured/activated/indicated between a TCI state for PDCCH or for a CORESET received by the UE and one of the M sets.

In another example, a UE is configured an association between reference signal resources used as source RS in the TCI state (e.g., main or indicated on unified TCI state or TCI state of a CORESET or a PDCCH received by the UE) and BFD-RS sets. For example, each RS resource i is associated with a BFD-RS set j. In one example, the association can be by including and a BFD-RS set index in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and the source RS included in the TCI state(s), a UE determines the BFD-RS set.

With reference to FIG. 18, this is shown. Based on the selected set, the UE determine the beam failure detection reference signal(s). A UE can measure or assess the signal quality, e.g., the reference signal received power (RSRP) of the reference signals and if the RSRP falls below a threshold (in one example, for one RS in the set, in another example for each RS in the set), a beam failure instance is declared (e.g., a beam failure instance indication is provided from the physical layer to the higher layers (e.g., MAC layer)). In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal.

In one example, the UE is configured a set of reference signals (or reference signal indices) for beam failure detection (e.g., BFD-RS). In one example, the set includes K reference signals. In one example, the reference signals are channel state information reference signal (CSI-RS). In one example, the reference signals are CSI-RS with one antenna port. In one example, the reference signals are an antenna port of a CSI-RS. In one example, the reference signals are SS/PBCH blocks. In one example, the reference signals are combination of CSI-RS (or one antenna port CSI-RS) and SS/PBCH blocks. In one example, the reference signals are LP-SS. In one example, the reference signals are a combination of CSI-RS (or one antenna port CSI-RS) and/or SS/PBCH blocks and/or LP-SS.

In one example, a UE is activated by dynamic signaling, e.g., MAC CE or L1 control information (e.g., DCI Format) N1 reference signals from the set of BFD-RS. In one example, N1=1. In one example, N1=2.

In another example, a UE is configured an association between TCI states or TCI state codepoints and BFD-RS resources in the BFD-RS set. For example, each TCI state i is associated with one or multiple BFD-RS j in the set of BFD-RS. In one example, the association can be by including and a BFD-RS index(es) in a TCI state. In one example, the association can be by including a BFD-RS index(es) in dynamic signaling, e.g., MAC CE or L1 control information (e.g., DCI Format) activating TCI states. In one example, the association can be by including a BFD-RS index(es) in dynamic signaling, e.g., MAC CE or L1 control information (e.g., DCI Format) indicating a TCI state or TCI state codepoint.

In one example, a UE determines N1 BFD-RS based on an association configured/activated/indicated between a unified or indicated or main TCI state and N1 of the N BFD-RS in the set. In one example, N1=1. In one example, N1=2. In one example, a UE determines N1 BFD-RS based on an association configured/activated/indicated between N1 unified or indicated or main TCI state(s) and N1 of the N BFD-RS in the set respectively. In one example, N1=1. In one example, N1-2. In another example, a UE determines N1 BFD-RS based on an association configured/activated/indicated between a TCI state for PDCCH or for a CORESET received by the UE and N1 of the N BFD-RS in the set. In one example, N1=1. In one example, N1-2. In another example, a UE determines N1 BFD-RS based on an association configured/activated/indicated between N1 TCI state for N1 PDCCH(es) or for N1 CORESET(s) received by the UE and N1 of the N BFD-RS in the set respectively. In one example, N1=1. In one example, N1-2.

In another example, a UE is configured an association between reference signal resources used as source RS in the TCI state (e.g., main or indicated on unified TCI state or TCI state of a CORESET or a PDCCH received by the UE) and BFD-RS resources in the BFD-RS set. For example, each RS resource i is associated with one or multiple BFD-RS j in the set of BFD-RS. In one example, the association can be by including a BFD-RS index(es) in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and based on the source RS included in the TCI state(s), a UE determines the BFD-RS resource(s).

In another example, a BFD-RS is selected from the BFD-RS set such that the BFD-RS is a source RS of a TCI state, or associated with the source RS of the TCI state by a QCL relation, (e.g., one is a QCL source of the other, or both have a same QCL source RS). Wherein, the TCI state can be the unified or indicated or main TCI state(s) and/or TCI state(s) of a CORESET(s).

With reference to FIG. 19, this is shown. Based on the N1 determined BFD-RS the UE can determine beam failure as described in the following. A UE can measure or assess the signal quality, e.g., the reference signal received power (RSRP) of the reference signals and if the RSRP falls below a threshold (in one example, for one RS in the set, in another example for each RS in the set), a beam failure instance is declared (e.g., a beam failure instance indication is provided from the physical layer to the higher layers (e.g., MAC layer)). In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha) * RSRP_int (n), where alpha is an exponential average coefficient. In variant example, RSRP (n)=(1-alpha) *RSPP (n−1)+alpha*RSRP_int (n). In one example, the RSRP is a sliding window average over N instances of the instantaneous RSRP measured in the most recent N instances of the reference signal.

When the physical layer detects a beam failure instance, an indication is sent to the MAC layer. The MAC layer starts a timer (e.g., beamFailureDetectionTimer) and increments a counter (e.g., BFI_COUNTER) by 1. If the counter reaches or exceeds a threshold before the timer expires, beam failure recovery is triggered. If the timer expires, the counter is reset to 0.

FIG. 20 illustrates a flowchart of an example UE procedure 2000 for determining presence of beam failure according to embodiments of the present disclosure. For example, procedure 2000 can be performed by the UE 116 of FIG. 3. This example is for illustration only and other embodiments can be used without departing from the scope of the present disclosure.

The procedure begins in 2010, a UE is configured with multiple sets of NBI-RSs. In 2020, the UE selects a BFR-RS set based on dynamic indication, an indicated TCI state, and/or a TCI state of a CORESET. In 2030, the UE measures NBI-RS based on selected NBI-RS set(s) to determine candidate beams for BFR.

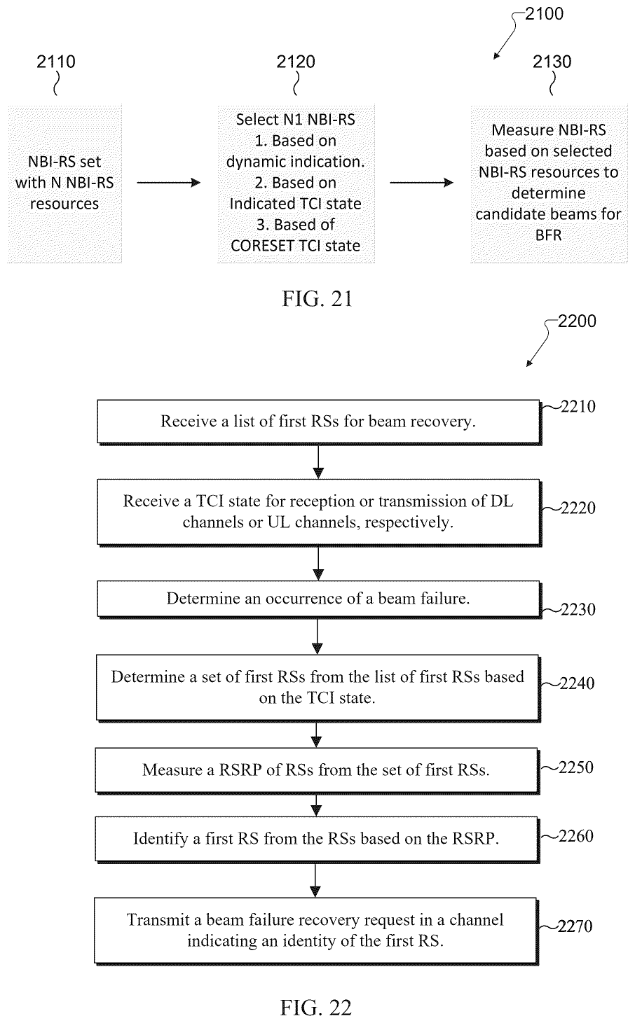

FIG. 21 illustrates a flowchart of an example UE procedure 2100 for determining presence of beam failure according to embodiments of the present disclosure. For example, procedure 2100 can be performed by any of the UEs 111-116 of FIG. 1, such as the UE 116. This example is for illustration only and other embodiments can be used without departing from the scope of the present disclosure.

The procedure begins in 2110, a UE is configured with a NBI-RS set with N NBI-RS resources. In 2120, the UE selects N1 NBI-RS based on dynamic indication, an indicated TCI state, and/or a TCI state of a CORESET. In 2130, the UE measures NBI-RS based on selected NBI-RS resources to determine candidate beams for BFR.

In one example, the UE is configured a set of reference signals (or reference signal indices) for new beam identification (NBI-RS) for beam failure recovery. In one example, the set includes N reference signals. In one example, the reference signals are channel state information reference signal (CSI-RS). In one example, the reference signals are CSI-RS with one antenna port. In one example, the reference signals are an antenna port of a CSI-RS. In one example, the reference signals are SS/PBCH blocks. In one example, the reference signals are combination of CSI-RS (or one antenna port CSI-RS) and SS/PBCH blocks. In one example, the reference signals are LP-SS. In one example, the reference signals are a combination of CSI-RS (or one antenna port CSI-RS) and/or SS/PBCH blocks and/or LP-SS. A UE (e.g., the UE 116) can measure or assess the signal quality, e.g., the reference signal received power (RSRP) of the reference signals and if the RSRP exceeds a threshold (or is greater than or equal to a threshold), the corresponding RS is a candidate for beam failure recovery. In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal. In one example, the set of NBI-RS is updated (removing NBI-RS that are not applicable based on the UE's current location in the network and adding NBI-RS that are applicable based on the UE's current location in the network) as the UE traverses the network. In one example, the location is based on the unified or main or indicated TCI state or TCI state of CORESET used by UE receive PDCCH. In one example, the TCI state is based on the TRP or RU or cell the UE uses to communicate with the network.

In one example, the UE is configured with multiple (e.g., M) sets of reference signals (or reference signal indices) for new beam identification (NBI-RS) for beam failure recovery. In one example, each set can include up to N reference signals. In one example, the reference signals are channel state information reference signal (CSI-RS). In one example, the reference signals are CSI-RS with one antenna port. In one example, the reference signals are an antenna port of a CSI-RS. In one example, the reference signals are SS/PBCH blocks. In one example, the reference signals are combination of CSI-RS (or one antenna port CSI-RS) and SS/PBCH blocks. In one example, the reference signals are LP-SS. In one example, the reference signals are a combination of CSI-RS (or one antenna port CSI-RS) and/or SS/PBCH blocks and/or LP-SS.

In one example, a UE is activated or indicated by dynamic signaling, e.g., MAC CE or L1 control information (e.g., DCI Format) M1 sets of the M sets, e.g., UE is signaled M1 IDs for M1 sets. The M1 sets are used for identifying a new beam as explained herein. In one example M1=1. In one example, M1=2. For example, the M1 sets can be determined based on the UE's current location in the network as the UE traverses the network as aforementioned.

In another example, a UE is configured an association between TCI states or TCI state codepoints and the M NBI-RS sets, wherein the UE is configured with M NBI-RS sets. For example, each TCI state i is associated with up to M1 NBI-RS sets. In one example M1=1. In one example, M1=2. In one example, the association can be by including up to M1 NBI-RS set indices in a TCI state. In one example, the association can be by including up to M1 NBI-RS set indices in dynamic signaling, e.g., MAC CE or L1 control information (e.g., DCI Format) activating TCI states. In one example, the association can be by including up to NBI-RS set indices in dynamic signaling, e.g., MAC CE or L1 control information (e.g., DCI Format) indicating a TCI state(s) or TCI state codepoint(s). In one example, a UE determines M1 sets of the M sets based on an association configured/activated/indicated between a unified or indicated or main TCI state(s) and M1 of the M sets. In another example, a UE determines M1 sets of the M sets based on an association configured/activated/indicated between a TCI state(s) for PDCCH(es) or for a CORESET(es) received by the UE and M1 of the M sets.

In another example, a UE is configured an association between reference signal resources used as source RS in the TCI state (e.g., main or indicated on unified TCI state or TCI state of a CORESET or a PDCCH received by the UE) and NBI-RS sets. For example, each RS resource i is associated with M1 NBI-RS sets. In one example M1=1. In one example, M1=2. In one example, the association can be by including up to M1 NBI-RS set indices in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and the source RS included in the TCI state(s), a UE determines up to M1 NBI-RS sets.

In another example, a UE is configured an association between the BFD-RS sets or BFD-RS resources and NBI-RS sets. For example, each BFD-RS set i or each BFD-RS resource i is associated with M1 NBI-RS sets. In one example M1=1. In one example, M1=2. In one example, the association can be by RRC configuration. In one example, the association can be by dynamic signaling e.g., MAC CE or L1 control (e.g., DCI Format) signaling. In one example, based on the BFD-RS sets or the BFD-RS resources used for beam failure detection, a UE determines up to M1 NBI-RS sets for beam failure recovery. In one example, based on the BFD-RS set(s) or the BFD-RS resource(s) that determine a beam failure, a UE determines up to M1 NBI-RS sets for beam failure recovery.

With reference to FIG. 20, this is shown. Based on the selected set(s), the UE determines the candidate reference signal(s) for beam failure recovery. A UE can measure or assess the signal quality, e.g., the reference signal received power (RSRP) of the reference signals and if the RSRP exceeds a threshold (or is greater than or equal to a threshold), the corresponding RS is a candidate for beam failure recovery. In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal.

In one example, the UE is configured a set of reference signals (or reference signal indices) for new beam identification (NBI-RS) for beam failure recovery. In one example, the set includes N reference signals. In one example, the reference signals are channel state information reference signal (CSI-RS). In one example, the reference signals are CSI-RS with one antenna port. In one example, the reference signals are an antenna port of a CSI-RS. In one example, the reference signals are SS/PBCH blocks. In one example, the reference signals are combination of CSI-RS (or one antenna port CSI-RS) and SS/PBCH blocks. In one example, the reference signals are LP-SS. In one example, the reference signals are a combination of CSI-RS (or one antenna port CSI-RS) and/or SS/PBCH blocks and/or LP-SS.

In one example, a UE is activated by dynamic signaling, e.g., MAC CE or L1 control information (e.g., DCI Format) N1 reference signals from the set of NBI-RS. For example, the N1 NBI-RS resources can be determined based on the UE's current location in the network as the UE traverses the network (e.g., the network 130) as aforementioned.

In another example, a UE is configured an association between TCI states or TCI state codepoints and NBI-RS resources in the NBI-RS set. For example, each TCI state i is associated with one or multiple NBI-RS j in the set of NBI-RS. In one example, the association can be by including and a NBI-RS index(es) in a TCI state. In one example, the association can be by including a NBI-RS index(es) in dynamic signaling, e.g., MAC CE or L1 control information (e.g., DCI Format) activating TCI states. In one example, the association can be by including a NBI-RS index(es) in dynamic signaling, e.g., MAC CE or L1 control information (e.g., DCI Format) indicating a TCI state or TCI state codepoint.

In one example, a UE determines N1 NBI-RS based on an association configured/activated/indicated between a unified or indicated or main TCI state and N1 of the N NBI-RS in the set. In one example, a UE determines N1 NBI-RS based on an association configured/activated/indicated between N2 unified or indicated or main TCI state(s) and N1 of the N NBI-RS in the set. In one example, N2=1. In one example, N2=2. In another example, a UE determines N1 NBI-RS based on an association configured/activated/indicated between a TCI state for PDCCH or for a CORESET received by the UE and N1 of the N NBI-RS in the set. In another example, a UE determines N1 NBI-RS based on an association configured/activated/indicated between N2 TCI state for N2 PDCCH(es), respectively or for N2 CORESET(s) received by the UE and N1 of the N NBI-RS in the set. In one example, N2=1. In one example, N2=2.

In another example, a UE is configured an association between reference signal resources used as source RS in the TCI state (e.g., main or indicated on unified TCI state or TCI state of a CORESET or a PDCCH received by the UE) and NBI-RS resources in the NBI-RS set. For example, each RS resource i is associated with one or multiple NBI-RS j in the set of NBI-RS. In one example, the association can be by including and a NBI-RS index(es) in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and based on the source RS included in the TCI state(s), a UE determines the NBI-RS resource(s).

In another example, a UE is configured an association between the BFD-RS sets or BFD-RS resources and NBI-RS resources in the NBI-RS set. For example, each BFD-RS set i or each BFD-RS resource i is associated with with one or multiple NBI-RS j in the set of NBI-RS. In one example, the association can be by RRC configuration. In one example, the association can be by dynamic signaling e.g., MAC CE or L1 control (e.g., DCI Format) signaling. In one example, based on the BFD-RS sets or the BFD-RS resources used for beam failure detection, a UE determines up to NBI-RS resources for beam failure recovery. In one example, based on the BFD-RS sets or the BFD-RS resources that determine a beam failure, a UE determines NBI-RS resources for beam failure recovery.

With reference to FIG. 21, this is shown. Based on the N1 determined NBI-RS the UE determines the candidate reference signal(s) for beam failure recovery as described in the following. A UE can measure or assess the signal quality, e.g., the reference signal received power (RSRP) of the reference signals and if the RSRP exceeds a threshold (or is greater than or equal to a threshold), the corresponding RS is a candidate for beam failure recovery. In one example, the UE measures a single instance of the reference signal to determine the RSRP. In one example, the RSRP is an exponential average e.g., if RSRP (n) is the RSRP at instance n and RSRP (n−1) is the RSRP at instance n−1 and RSRP_int (n) is the instantaneous RSRP measured during instance n, RSRP (n)=alpha*RSPP (n−1)+(1-alpha)*RSRP_int (n), where alpha is an exponential average coefficient. In variant example, RSRP (n)=(1-alpha)*RSPP (n−1)+alpha*RSRP_int (n). In one example, the RSRP is a sliding window average over N instances of the instantaneous RSRP measured in the most recent N instances of the reference signal.

In one example, when beam failure recovery is triggered as a result of beam failure detection, and candidate beam(s) are identified for beam failure recovery (e.g., based on NBI-RS). If more than one candidate beams (e.g., NBI-RSs) are identified a UE selects a candidate beam (e.g., NBI-RS) from the candidate beams. In one example, the selected candidate beam (e.g., NBI-RS) is based on the RSRP, e.g., the candidate beam (e.g., NBI-RS) with the largest RSRP is selected. In one example, the selected candidate beam (e.g., NBI-RS) is based on the UE's implementation. For example, if multiple candidate beams (e.g., NBI-RSs) exceed a threshold, a UE can select a candidate beam (e.g., NBI-RS) from the candidate beams (e.g., NBI-RSs) that exceed the threshold based on its implementation. A UE can send a beam failure recovery request as described in this disclosure to indicate the candidate beam (e.g., NBI-RS).

In one example, when beam failure recovery is triggered as a result of beam failure detection, and candidate beam(s) (e.g., NBI-RS(s)) are identified for beam failure recovery. A UE selects K or up to K candidate beam(s) from the candidate beams. In one example, the selected candidate beam(s) are based on the RSRP, e.g., the K candidate beam(s) with the largest RSRP are selected. In one example, the selected candidate beam(s) are based on the UE's implementation. For example, the UE selects from the set of candidate beams that exceed a threshold. A UE can send a beam failure recovery request as described in this disclosure to indicate the K candidate beam(s) (e.g., NBI-RS(s)).

In one example, when beam failure recovery is triggered as a result of beam failure detection, and candidate beam(s) (e.g., NBI-RS(s)) are identified for beam failure recovery. A UE can send a beam failure recovery request as described in this disclosure to indicate the candidate beam(s) (e.g., NBI-RS(s)).

In one example, after a UE detects a beam failure, and identifies a candidate beam (or multiple candidate beams), a UE transmits a beam failure recovery request (BFRQ) to the network, wherein the BFRQ indicates the identity of the UE with beam failure and the identity of candidate beam(s) (e.g., NBI-RS(s)).

In one example, the resource used for BFRQ, depends on, or is determined based on an association (wherein the association is configured to the UE) with, (1) unified or main or indicated TCI state or a set such TCI state is included in, or (2) TCI state of CORESET or PDCCH received by UE or a set of such TCI state, or (3) the BFD-RS ID to determine beam failure or the set of such BFD-RS, or (4) the NBI-RS ID identified as candidate beam for beam recovery or the set of such NBI-RS or (5) the ID of the NBI-RS set used to identify a candidate beam for beam recovery.

In one example the BFRQ is transmitted use a PRACH preamble as explained herein. In one example, the BFRQ is transmitted using a scheduling request (e.g., link recovery request), and the scheduling request can be followed by an UL transmission on physical UL shared channel (PUSCH) (e.g., scheduled or unscheduled PUSCH). In the following examples, PRACH configuration is used an example of a configuration of a channel carrying BFRQ, and can be substituted by “configuration of a channel carrying the BFRQ”

In one example, the BFRQ is a contention-free random access (CFRA) procedure, wherein the PRACH resource identifies the UE sending the BFRQ and the identity of the candidate beam. In one example, if multiple candidate beams are identified, multiple PRACH resources are transmitted to the network, e.g., a PRACH resource associated with each candidate beam (e.g., NBI-RS). In one example, a PRACH resource is determined by a preamble sequence and a PRACH occasion (RO) index used for the PRACH transmission.

In one example, the BFRQ is a contention-based random access (CBRA) procedure, wherein a contention based preamble is transmitted. For a Type-1 random access procedure, the UE identity and candidate beams (e.g., ID of NBI-RS) can be transmitted to the network in message 3 of the random access procedure. For a Type-2 random access procedure, the UE identity and candidate beams can be transmitted to the network in the msgA PUSCH.

In one example, a UE receives M PRACH configurations, wherein a PRACH configuration can include: (1) A configuration index. (2) Information related to the preamble format and the preamble sequence such as: PRACH preamble format, zero correlation zone config (to determine the Ncs), root sequence index, and restricted set configuration (for long preamble formats, e.g., with sequence length 839). (3) time domain information of the PRACH occasion, such as radio frame, sub-frame within radio frame, PRACH slot with subframe, and starting symbol with PRACH slot, PRACH duration in symbols, in one example some or all of these can be determined based on a PRACH configuration index, and PRACH configuration index can also determine preamble format. (4) frequency domain information of the PRACH occasion such as starting PRB, and number of FDMed frequency occasions.

In one example a PRACH configuration is provided by one or more of the following parameters:
A configuration index (e.g., from 0 to M−1 or from 1 to M)
A prach-ConfigurationIndex, that provides: (1) a preamble format, (2) a frame number for PRACH occasions, e.g., based on periodicity in frames and offset within periodicity in frames, (3) subframe(s) for PRACH occasions, (4) starting symbol for first PRACH occasion within PRACH slot or within subframe, (5) number of PRACH slots within subframe, (6) number of time domain PRACH occasions with a PRACH slot, and (7) duration of PRACH slot in symbols.
zero correlation zone config (to determine the N_CS).
PRACH root sequence index
Restricted set configuration
Preamble sequence length (e.g., 139)
Number of frequency division multiplexed PRACH occasions
Starting PRB frequency of the first PRACH occasion.
Number of SSBs or CSI-RS resources associated with PRACH occasion. If number is less than 1, multiple PRACH occasions are associated with a SSB or CSI-RS resource.

In one example, the PRACH occasions of a configuration (of the M configurations) are indexed first in increasing order of frequency resource indexes for frequency multiplexed PRACH occasions; second in increasing order of time resource indexes for time multiplexed PRACH occasions within a PRACH slot; and third in increasing order of indexes for PRACH slots. Each PRACH occasion can include N preamble indices, e.g., 0, 1, . . . , N−1. In one example N=64.

In one example, L RO groups are configured, wherein an RO group includes an RO group index (e.g., from 0 to L-1 or from 1 to L), and a list of PRACH occasions (e.g., K PRACH occasions).

In one example (e.g., for CFRA), a NBI-RS is associated with PRACH resources. The association can be based on:
NBI-RS index
Configuration index (for 1 of the M PRACH configurations)
A list of K PRACH occasions, or a RO group index of one of the L RO groups.
A preamble index within each of the K PRACH occasions. In one example, one preamble index is provided that is common for each the K PRACH occasions. In one example, a list of K preamble indices is provided with one entry for each preamble occasion of the K preamble occasions.

In one example (e.g., for CFRA), a NBI-RS is associated with PRACH resources. The association can be based on:
NBI-RS index
Time and frequency resources of PRACH occasion, for example, this can be provided by starting PRB, periodicity in time domain (e.g., in frames or sub-frames or slots or symbols (based on a sub-carrier spacing)), and offset within periodicity (in frames and/or sub-frames and/or slots and/or symbols), and time domain RO number within a slot or within a sub-frame.
A preamble index within each occasion.

In one example (e.g., for CFRA), there are M PRACH configuration and M NBI-RS resource sets. Each NBI-RS resource set is associated with a corresponding PRACH configuration. For example, the first NBI-RS resource set is associated with the first PRACH configuration. The second NBI-RS resource set is associated with the second PRACH configuration and so on. Each NBI-RS resource of an NBI-RS resource set is associated with PRACH resources of the corresponding PRACH configuration. The association can be based on:
NBI-RS index within the NBI-RS resource set.
A list of K PRACH occasions, or a RO group index one of the L RO groups of the corresponding PRACH configuration.
A preamble index within each of the K PRACH occasions. In one example, one preamble index is provided that is common for each the K PRACH occasions. In one example, a list of K preamble indices is provided with one entry for each preamble occasion of the K preamble occasions.

In one example (e.g., for CFRA), there are M1 PRACH configurations and M2 NBI-RS resource sets. Each NBI-RS resource set is associated with a corresponding PRACH configuration. In one example, the association can be by RRC configuration, for example, the NBI-RS resource set can include an index of the corresponding PRACH configuration of the M1 PRACH configurations. In one example, the association can be by RRC configuration, for example, the PRACH configuration can include an index of the corresponding NBI-RS resource set(s) of the M2 NBI-RS resource sets. Each NBI-RS resource of an NBI-RS resource set is associated with PRACH resources of the corresponding PRACH configuration. The association can be based on:
NBI-RS index within the NBI-RS resource set.
A list of K PRACH occasions, or a RO group index of one of the L RO groups of the corresponding PRACH configuration.
A preamble index within each of the K PRACH occasions. In one example, one preamble index is provided that is common for the K PRACH occasions. In one example, a list of K preamble indices is provided with one entry for each preamble occasion of the K preamble occasions.

In one example, a TCI state is associated with a PRACH configuration (for CFRA or CBRA). For example, this association can be based on mapping:
TCI state ID/index or TCI state set ID/index.
PRACH configuration index from M PRACH configurations.

In one example (e.g., for CFRA or CBRA), there are M PRACH configurations. A UE determines a PRACH configuration for BFRQ based on an association configured/activated/indicated between a unified or indicated or main TCI state and a PRACH configuration of the M PRACH configurations. In one example, a UE determines a PRACH configuration for BFRQ based on an association configured/activated/indicated between N2 unified or indicated or main TCI state(s) and a PRACH configuration of the M PRACH configurations. In one example, N2=1. In one example, N2=2. In another example, a UE determines a PRACH configuration for BFRQ based on an association configured/activated/indicated between a TCI state for PDCCH or for a CORESET received by the UE and a PRACH configuration of the M PRACH configurations. In another example, a UE determines a PRACH configuration for BFRQ based on an association configured/activated/indicated between N2 TCI state for N2 PDCCH(es), respectively or for N2 CORESET(s) received by the UE and a PRACH configuration of the M PRACH configurations. In one example, N2=1. In one example, N2=2.

In one example (e.g., for CFRA or CBRA), there are M PRACH configurations. A UE is configured an association between reference signal resources used as source RS in the TCI state (e.g., main or indicated on unified TCI state or TCI state of a CORESET or a PDCCH received by the UE) and PRACH configurations. For example, each RS resource i is associated with a PRACH configuration j of the M PRACH configurations. In one example, the association can be by including and a configuration index of one of the M PRACH configurations in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and based on the source RS included in the TCI state(s), a UE determines a PRACH configuration of one of the M PRACH configurations.

In one example (e.g., for CBRA), a NBI-RS is associated with PRACH configuration from which to select a preamble for contention-based random access. The association can be based on:
NBI-RS index or NBI-RS resource set index.
Configuration index (for 1 of the M PRACH configurations)

In one example (e.g., for CBRA), there are M PRACH configuration and M NBI-RS resource sets. Each NBI-RS resource set is associated with a corresponding PRACH configuration. For example, the first NBI-RS resource set is associated with the first PRACH configuration. The second NBI-RS resource set is associated with the second PRACH configuration and so on. A NBI-RS selects a contention-based preamble from a PRACH configuration corresponding to the NBI-RS resource set of the NBI-RS resource(s) identified as a candidate beam.

In one example (e.g., for CBRA), there are M1 PRACH configurations and M2 NBI-RS resource sets. Each NBI-RS resource set is associated with a corresponding PRACH configuration. In one example, the association can be by RRC configuration, for example the NBI-RS resource set, can include an index of the corresponding PRACH configuration of the M1 PRACH configurations. In one example, the association can be by RRC configuration, for example, the PRACH configuration can include an index of the corresponding NBI-RS resource set(s) of the M2 NBI-RS resource sets. A NBI-RS selects a contention-based preamble from a PRACH configuration corresponding to the NBI-RS resource set of the NBI-RS resource.

In response to the BFR Q the network provides a Beam Failure Recovery response (BFRR). In one example, a beam failure recovery response, e.g., a DCI Format in a PDCCH, is provided in a recovery search space.

In one example a UE receives M recovery search space configurations. Each recovery search space configuration is associated with a recovery search space configuration index (e.g., from 0 to M−1 or from 1 to M).

In one example, the recovery search space, depends on, or is determined based on an association (wherein the association is configured to the UE) with, (1) unified or main or indicated TCI state or a set such TCI state is included in, or (2) TCI state of CORESET or PDCCH received by UE or a set of such TCI state, or (3) the BFD-RS ID to determine beam failure or the set of such BFD-RS, or (4) the NBI-RS ID identified as candidate beam for beam recovery or the set of such NBI-RS ID, or (5) the ID of the NBI-RS set used to identify a candidate beam for beam recovery (6) the configuration used for the channel carrying the BFRQ.

In one example, a NBI-RS resource is associated with a recovery search space configuration. For example, this association can be based on mapping:
NBI-RS index or NBI-RS resource set index.
Recovery search space index

In one example, there are M recovery search space configurations and M NBI-RS resource sets. Each NBI-RS resource set is associated with a corresponding recovery search space configuration. For example, the first NBI-RS resource set is associated with the first recovery search space configuration. The second NBI-RS resource set is associated with the second recovery search space configuration and so on.

In one example, there are M1 recovery search space configurations and M2 NBI-RS resource sets. Each NBI-RS resource set is associated with a corresponding recovery search space configuration. In one example, the association can be by RRC configuration, for example the NBI-RS resource set, can include an index of the corresponding recovery search space configuration of the M1 recovery search space configurations. In one example, the association can be by RRC configuration, for example, the recovery search space configuration can include an index of the corresponding NBI-RS resource set(s) of the M2 NBI-RS resource sets.

In one example, there are M recovery search space configurations and M PRACH configurations. Each PRACH configuration is associated with a corresponding recovery search space configuration. For example, the first PRACH configuration is associated with the first recovery search space configuration. The second PRACH configuration is associated with the second recovery search space configuration and so on.

In one example, there are M1 recovery search space configurations and M2 PRACH configurations. Each PRACH configuration is associated with a corresponding recovery search space configuration. In one example, the association can be by RRC configuration, for example the PRACH configuration, can include an index of the corresponding recovery search space configuration of the M1 recovery search space configurations.

In one example, there are M1 recovery search space configurations and M2 PRACH configurations. Each recovery search space configuration is associated with a corresponding PRACH configuration. In one example, the association can be by RRC configuration, for example the recovery search space configuration, can include an index of the corresponding PRACH configuration of the M2 PRACH configurations.

In one example, a TCI state is associated with a recovery search space configuration. For example, this association can be based on mapping:
TCI state ID/index or TCI state set ID/index.
Recovery search space index from M recovery search space configurations.

In one example, there are M recovery search space configurations. A UE determines a recovery search space configuration for BFRR based on an association configured/activated/indicated between a unified or indicated or main TCI state and a recovery search space configuration of the M recovery search space configurations. In one example, a UE determines a recovery search space configuration for BFRR based on an association configured/activated/indicated between N2 unified or indicated or main TCI state(s) and a recovery search space configuration of the M recovery search space configurations. In one example, N2=1. In one example, N2-2. In another example, a UE determines a recovery search space configuration for BFRR based on an association configured/activated/indicated between a TCI state for PDCCH or for a CORESET received by the UE and a recovery search space configuration of the M recovery search space configurations. In another example, a UE determines a recovery search space configuration for BFRQ based on an association configured/activated/indicated between N2 TCI state for N2 PDCCH(es), respectively or for N2 CORESET(s) received by the UE and a recovery search space configuration of the M recovery search space configurations. In one example, N2=1. In one example, N2=2.

In one example, there are M recovery search space configurations. A UE is configured an association between reference signal resources used as source RS in the TCI state (e.g., main or indicated on unified TCI state or TCI state of a CORESET or a PDCCH received by the UE) and recovery search space configurations. For example, each RS resource i is associated with a recovery search space configuration j of the M recovery search space configurations. In one example, the association can be by including and a configuration index of one of the M recovery search space configurations in a RS resource or RS resource set configuration. In one example, the association can be by dynamic signaling e.g., MAC CE or L1 control (e.g., DCI Format) signaling. Based on the unified or indicated or main TCI state(s) and/or TCI state(s) of a CORESET(s), and based on the source RS included in the TCI state(s), a UE determines a recovery search space configuration of one of the M recovery search space configurations.

In one example, the UE continues to monitor PDCCH candidates in the recovery search space set, determined as mentioned herein, until the UE receives dynamic signaling, e.g., MAC CE or L1 control, activating or indicating TCI state(s).

FIG. 22 illustrates an example method 2200 performed by a UE in a wireless communication system according to embodiments of the present disclosure. The method 2200 of FIG. 22 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2200 is for illustration only and other embodiments can be used without departing from the scope of the present disclosure.

The method 2200 begins with the UE receiving a list of first RSs for beam recovery (2210). The UE then receives a TCI state for reception or transmission of DL channels or UL channels, respectively (2220). The UE then determines an occurrence of a beam failure (2230). In various embodiments, the occurrence of the beam failure is determined based on a RSRP measurement of a second RS and the second RS is determined based on the TCI state.

The UE then determines a set of first RSs from the list of first RSs based on the TCI state (2240). In various embodiments, the list of first RSs include multiple sets of the first RSs, and the UE receives an identifier of a set of the multiple sets. In various embodiments, the UE receives configuration information associating the TCI state with the set of first RSs.

The UE then measures a RSRP of RSs from the set of first RSs (2250). The UE then identifies a first RS from the RSs based on the RSRP (2260). The UE then transmits a beam failure recovery request in a channel indicating an identity of the first RS (2270). In various embodiments, the UE determines a resource for the channel indicating the identity of the first RS and the resource is determined based on an association with the set of first RSs.

In various embodiments, the channel indicating the identity of the first RS is a PRACH and the UE receive multiple configurations of the PRACH, receives information indicating associations between the multiple configurations of the PRACH and multiple sets of first RSs, respectively, the multiple sets of first RSs including the set of first RSs, determines a preamble of the PRACH based on an ID of the first RS, and determines a configuration of the PRACH based on an association, from the associations, between the configuration and the first RSs.

In various embodiments, the UE receives multiple configurations of a recovery search space, receives information indicating associations between the multiple configurations of the recovery search space and multiple sets of first RSs, respectively, the multiple sets of first RSs including the set of first RSs, determines an ID of the recovery search space based on an association, from the associations, with the set of first RSs, and receives a beam failure recovery response in the determined recovery search space.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a list of first reference signals (RSs) for beam recovery, and
receive a transmission configuration indicator (TCI) state for reception or transmission of downlink (DL) channels or uplink (UL) channels, respectively; and
a processor operably coupled to the transceiver, the processor configured to:
determine an occurrence of a beam failure,
determine a set of first RSs from the list of first RSs based on the TCI state,
measure a reference signal received power (RSRP) of RSs from the set of first RSs, and
identify a first RS from the RSs based on the RSRP,
wherein the transceiver is further configured to transmit a beam failure recovery request (BFRQ) in a channel indicating an identity of the first RS.

2. The UE of claim 1, wherein:
the occurrence of the beam failure is determined based on a RSRP measurement of a second RS, and
the second RS is determined based on the TCI state.

3. The UE of claim 1 wherein:
the list of first RSs include multiple sets of the first RSs, and
the transceiver is further configured to receive an identifier of a set of the multiple sets.

4. The UE of claim 1 wherein the transceiver is further configured to receive configuration information associating the TCI state with the set of first RSs.

5. The UE of claim 1 wherein:
the processor is further configured to determine a resource for the channel indicating the identity of the first RS, and
the resource is determined based on an association with the set of first RSs.

6. The UE of claim 1 wherein:
the channel indicating the identity of the first RS is a physical random access channel (PRACH),
the transceiver is further configured to:
receive multiple configurations of the PRACH, and
receive information indicating associations between the multiple configurations of the PRACH and multiple sets of first RSs, respectively, the multiple sets of first RSs including the set of first RSs, and
the processor is further configured to:
determine a preamble of the PRACH based on an identifier (ID) of the first RS, and
determine a configuration of the PRACH based on an association, from the associations, between the configuration and the first RSs.

7. The UE of claim 1 wherein:
the transceiver is further configured to:
receive multiple configurations of a recovery search space, and
receive information indicating associations between the multiple configurations of the recovery search space and multiple sets of first RSs, respectively, the multiple sets of first RSs including the set of first RSs,
the processor is further configured to determine an identifier (ID) of the recovery search space based on an association, from the associations, with the set of first RSs, and
the transceiver is further configured to receive a beam failure recovery response in the determined recovery search space.

8. A base station (BS), comprising:
a transceiver configured to:
transmit a list of first reference signals (RSs) for beam recovery, and
transmit a transmission configuration indicator (TCI) state for transmission or reception of downlink (DL) channels or uplink (UL) channels, respectively; and
a processor operably coupled to the transceiver, the processor configured to determine a set of first RSs from the list of first RSs based on the TCI state,
wherein the transceiver is further configured to receive a beam failure recovery request (BFRQ) in a channel indicating an identity of a first RS, from the first set of RSs, for beam failure recovery.

9. The BS of claim 8 wherein:
the list of first RSs include multiple sets of the first RSs, and
the transceiver is further configured to transmit an identifier of a set of the multiple sets.

10. The BS of claim 8 wherein the transceiver is further configured to transmit configuration information associating the TCI state with the set of first RSs.

11. The BS of claim 8 wherein:
the processor is further configured to determine a resource for the channel indicating the identity of the first RS, and
the resource is determined based on an association with the set of first RSs.

12. The BS of claim 8 wherein:
the channel indicating the identity of the first RS is a physical random access channel (PRACH),
the transceiver is further configured to:
transmit multiple configurations of the PRACH, and
transmit information indicating associations between the multiple configurations of the PRACH and multiple sets of first RSs, respectively, the multiple sets of first RSs including the set of first RSs, and
the processor is further configured to determine a configuration of the PRACH based on an association, from the associations, between the configuration and the set of the first RSs, and
the transceiver is further configured to receive the PRACH on the determined PRACH configuration and determine the identity of the first RS based on a detected preamble.

13. The BS of claim 8 wherein:
the transceiver is further configured to:
transmit multiple configurations of recovery search space, and
transmit information indicating associations between the multiple configurations of the recovery search space and multiple sets of first RSs, respectively, the multiple sets of first RSs including the set of first RSs, and
the processor is further configured to determine an identifier (ID) of the recovery search space based on an association, from the associations, with the set of the first RSs, and
the transceiver is further configured to transmit, in response to the BFRQ, a beam failure recovery response in the determined recovery search space.

14. A method of operating a user equipment (UE), the method comprising:
receiving a list of first reference signals (RSs) for beam recovery;
receiving a transmission configuration indicator (TCI) state for reception or transmission of downlink (DL) channels or uplink (UL) channels, respectively;
determining an occurrence of a beam failure;
determining a set of first RSs from the list of first RSs based on the TCI state;
measuring a reference signal received power (RSRP) of RSs from the set of first RSs;
identifying a first RS from the RSs based on the RSRP; and
transmitting a beam failure recovery request (BFRQ) in a channel indicating an identity of the first RS.

15. The method of claim 14, wherein:
the occurrence of the beam failure is determined based on a RSRP measurement of a second RS, and
the second RS is determined based on the TCI state.

16. The method of claim 14, wherein:
the list of first RSs include multiple sets of the first RSs, and
method further comprises receiving an identifier of a set of the multiple sets.

17. The method of claim 14, wherein the method further comprises receiving configuration information associating the TCI state with the set of first RSs.

18. The method of claim 14, wherein:
method further comprises determining a resource for the channel indicating the identity of the first RS, and
the resource is determined based on an association with the set of first RSs.

19. The method of claim 14, wherein:
the channel indicating the identity of the first RS is a physical random access channel (PRACH),
the method further comprises:
receiving multiple configurations of the PRACH,
receiving information indicating associations between the multiple configurations of PRACH and multiple sets of first RSs, respectively, the multiple sets of first RSs including the set of first RSs,
determining a preamble of the PRACH based on an identifier (ID) of the first RS, and
determining a configuration of the PRACH based on an association, from the associations, between the configuration and the first RSs.

20. The UE of claim 14, wherein the method further comprises:
receiving multiple configurations of a recovery search space,
receiving information indicating associations between the multiple configurations of the recovery search space and multiple sets of first RSs, respectively, the multiple sets of first RSs including the set of first RSs,
determining an identifier (ID) of the recovery search space based on an association, from the associations, with the set of the first RSs, and
receiving a beam failure recovery response in the determined recovery search space.
